(19) United States
(12) Patent Application Publication
(10) Pub. No.: US 2007/0080899 A1
(43) Pub. Date: Apr. 12, 2007

(54) Plasma display device and driving method thereof

(76) Inventors: Hak-Cheol Yang, Yongin-si (KR); Joon-Yeon Kim, Yongin-si (KR); Yong jin Jeong, Yongin-si (KR); Hyun-Gu Heo, Yongin-si (KR); Jong-Ki Choi, Yongin-si (KR)

Correspondence Address: CHRISTIE, PARKER & HALE, LLP, PO BOX 7068, PASADENA, CA, 91109-7068, US

(21) Appl. No.: 11/543,325

(22) Filed: Oct. 4, 2006

(30) Foreign Application Priority Data
Oct. 12, 2005 (KR) 10-2005-0095996

(51) Int. Cl. G09G 3/28

(52) U.S. Cl. 345/63

(57) ABSTRACT

A plasma display device and a method for driving the plasma display device. In a first subfield, a first voltage is alternately applied to the first and second electrodes by applying a first addressing scheme for converting an on-cell to an off-cell for a sustain period. In a second subfield, the off-cell is converted to the light emitting state. Initialization in a reset period is appropriately performed whether a write addressing method or an erase addressing method is used.

### CROSS-REFERENCE TO RELATED APPLICATION

This application claims priority to and the benefit of Korean Patent Application No. 10-2005-0095996 filed in the Korean Intellectual Property Office on Oct. 12, 2005, the entire content of which is incorporated herein by reference.

### BACKGROUND OF THE INVENTION

1. Field of the Invention

The present invention relates to a plasma display device and a driving method thereof.

2. Description of the Related Art

A plasma display device is a flat panel display that uses plasma generated by a gas discharge process to display characters or images. It includes a plurality of discharge cells arranged in a matrix pattern.

One frame of the plasma display device is divided into a plurality of subfields each having a corresponding weight. A turn-on discharge cell is selected among a plurality of discharge cells by performing an addressing discharge for an address period of each subfield, and the turn-on discharge cell is sustain-discharged for a sustain period of each subfield so as to display an image.

A scan pulse is applied to display regions in order to select a turn-on discharge cell among discharge cells formed at crossing areas of the display regions and address electrodes. In addition, a scan circuit is required to apply the scan pulse to the respective display regions for selecting a display region. The scan circuits are coupled to their corresponding scan electrodes.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a plasma display device for reducing the number of scan circuits and stably generating a weak discharge during a main reset period, and a driving method thereof.

An exemplary method according to an embodiment of the present invention drives a plasma display device during frames divided into a plurality of subfields. The plasma display device includes a plurality of first electrodes, a plurality of second electrodes, and a plurality of third electrodes formed in a direction crossing a direction of the plurality of first electrodes and the plurality of second electrodes.

In the exemplary method, for an address period of a first subfield, a plurality of on-cells are selected according to a first addressing scheme in which one or more of the on-cells are converted into non-emitting or off state. In addition, a first voltage, which is a sustain discharge voltage, is alternately applied to the plurality of first electrodes and the plurality of second electrodes for a sustain period of the first subfield. For a first period, a voltage is applied to the first and third electrodes for a voltage difference between the first electrodes and the third electrodes to be a second voltage that is greater than a voltage difference between the first and second electrodes in the sustain period of the first subfield. In addition, in a second subfield, an on-cell is selected according to a second addressing scheme in which one or more of the off-cells are converted into a light emitting state and then a sustain-discharge is generated in the converted cells.

Another exemplary method according to an embodiment of the present invention drives a plasma display device including a plurality of first electrodes, a plurality of second electrodes, and a plurality of third electrodes formed in a direction crossing a direction of the first and second electrodes. In this exemplary method, an on-cell is selected according to a first addressing scheme in which the on-cell is converted into a non-emitting or off state and then a sustain-discharge is generated in the converted cell, and for a first period, a discharge is generated in the cell converted into the non-emitting or off state by the first address scheme. In addition, a reset-discharge is generated for initializing all the discharge cells.

Another exemplary plasma display device according to an embodiment of the present invention includes a plasma display panel and a driver. The plasma display panel includes a plurality of first electrodes, a plurality of second electrodes, and a plurality of third electrodes formed in a direction crossing the plurality of first electrodes and the plurality of second electrodes. The driver applies a voltage in order for a voltage difference between the plurality of first electrodes and the plurality of third electrodes during a first period located between a first subfield and a second subfield to be greater than a voltage difference between the first and second electrodes in a sustain period of the first subfield. During the first subfield, the driver alternately applies a first voltage to the plurality of first electrodes and the plurality of second voltages during the sustain period according to a first addressing scheme for converting a cell from a light-emitting or on state into a non-emitting or off state. During the second subfield, the driver uses a second addressing scheme for converting a cell from the off state into an on state.

### BRIEF DESCRIPTION OF THE DRAWINGS

FIG. 1 shows a diagram representing a plasma display device according to an exemplary embodiment of the present invention.

FIG. 2 shows an electrode arrangement diagram of a plasma display panel (PDP) according to a first exemplary embodiment of the present invention.

FIG. 3 shows an electrode arrangement diagram of the PDP according to a second exemplary embodiment of the present invention.

FIG. 4 shows a diagram for representing a driving method of the plasma display device according to an exemplary embodiment of the present invention.

FIG. 5 shows a diagram representing driving waveforms applied to first to third subfields SF1 to SF3, among driving waveforms of the plasma display device according to the exemplary embodiment of the present invention.

FIG. 6 shows a diagram representing driving waveforms applied in a fourth subfield SF4 among the driving waveforms of the plasma display device according to the exemplary embodiment of the present invention.

FIG. 7 shows a diagram representing driving waveforms applied in a fifth subfield SF5 among the driving waveforms of the plasma display device according to the exemplary embodiment of the present invention.

FIG. 8 shows a diagram representing driving waveforms applied in a tenth subfield SF10 among the driving waveforms of the plasma display device according to the exemplary embodiment of the present invention.

FIG. 9A, FIG. 9B, and FIG. 9C each show a wall charge distribution state resulting from the driving waveforms of FIG. 8.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and claims which follow, unless explicitly described to the contrary, the word “comprise/include” or variations such as “comprises/includes” or “comprising/including” will be understood to imply the inclusion of stated elements but not the exclusion of any other elements.

Wall charges mentioned in the following description mean charges formed and accumulated on a wall (e.g., a dielectric layer) close to an electrode of a discharge cell. In addition, although the wall charges do not actually touch the electrodes, the wall charge will be described as being “formed” or “accumulated” on the electrode. Further, a wall voltage means a potential formed on the wall of the discharge cell by the wall charge.

A plasma display device according to an exemplary embodiment of the present invention and a driving method thereof will be described with reference to the accompanying drawings.

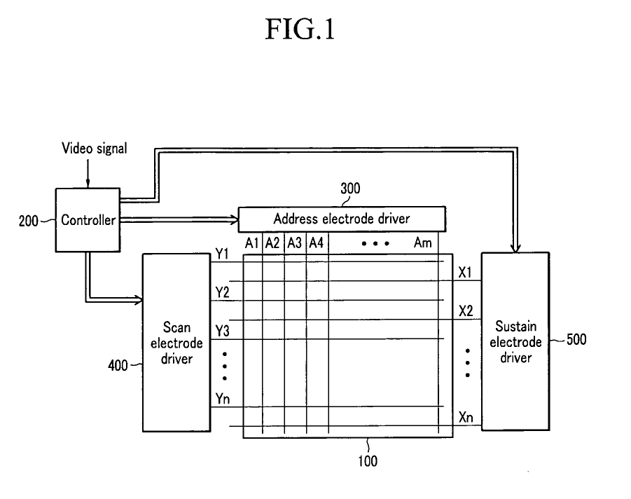

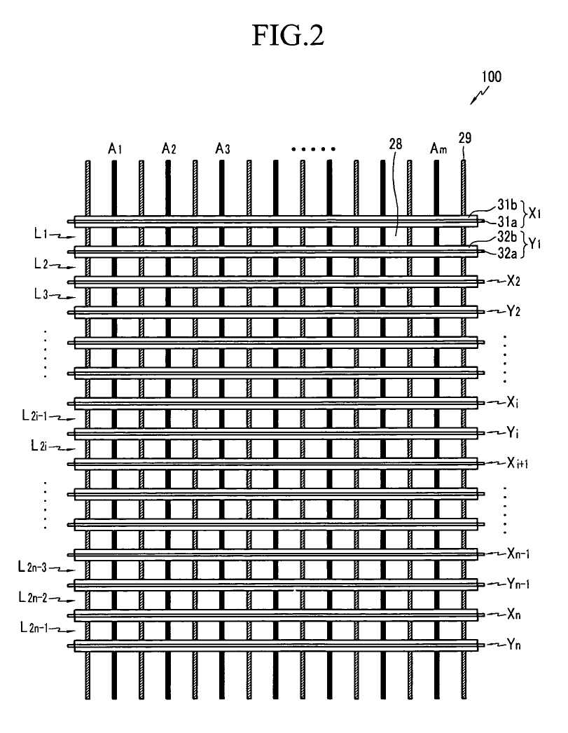

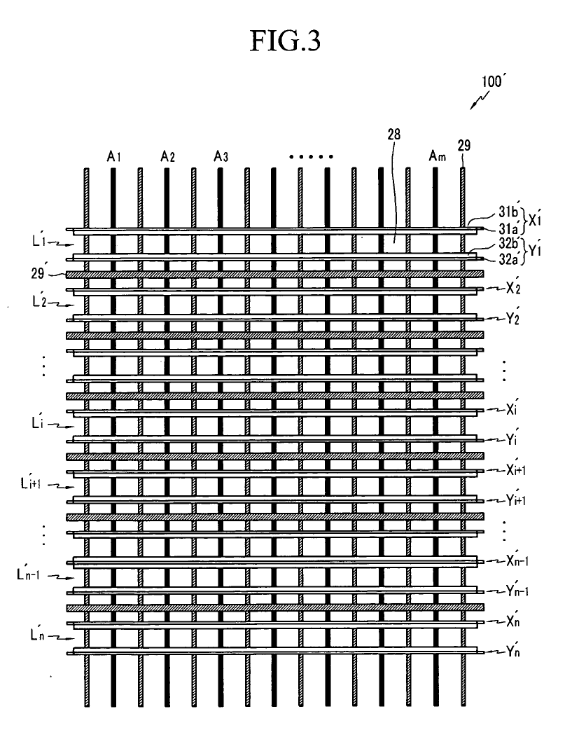

First, the plasma display device according to the exemplary embodiment of the present invention will be described with reference to FIG. 1, FIG. 2, and FIG. 3.

FIG. 1 shows a diagram representing the plasma display device according to the exemplary embodiment of the present invention.

As shown in FIG. 1, the plasma display device includes a plasma display panel (PDP) 100, a controller 200, an address electrode driver 300, a scan electrode driver 400, and sustain electrode driver 500.

The PDP 100 includes a plurality of address electrodes A1 to Am extending in a column direction, and a plurality of sustain and scan electrodes X1 to Xn and Y1 to Yn extending in a row direction by pairs.

The controller 200 receives an external video signal and outputs an address electrode driving control signal, a sustain electrode driving control signal, and a scan electrode driving control signal. In addition, the controller 200 divides a frame into a plurality of subfields each having a corresponding brightness weight, and drives the plasma display device during the subfields. According to the exemplary embodiment of the present invention, the controller 200 divides the plurality of sustain electrodes X1 to Xn into odd-numbered sustain electrodes Xodd and even-numbered sustain electrodes Xeven.

After receiving the address electrode driving control signal from the controller 200, the address electrode driver 300 applies a data driving voltage to the address electrodes A1 to Am.

The scan electrode driver 400 applies a scan driving voltage to the scan electrodes Y1 to Yn after receiving the scan electrode driving control signal from the controller 200.

The sustain electrode driver 500 applies a sustain driving voltage to the sustain electrodes X1 to Xn after receiving the sustain electrode driving control signal from the controller 200.

FIG. 2 shows an electrode arrangement diagram of the PDP according to a first exemplary embodiment of the present invention.

As shown in FIG. 2, the PDP 100 includes the plurality of address electrodes A1 to Am extending in a column direction, and the plurality of sustain and scan electrodes X1 to Xn and Y1 to Yn extending in a row direction by pairs. The address electrodes A1 to Am are formed on one substrate, and the sustain electrodes X1 to Xn and the scan electrodes Y1 to Yn are formed on another substrate, such that the two substrates may face each other. Display regions L1 to L(2n−1) for displaying an image are formed between two neighboring scan and sustain electrodes. For example, a display region L1 is formed between a first scan electrode Y1 and a first sustain electrode X1, and a display region L2 is formed between the first scan electrode Y1 and a second sustain electrode X2. That is, every two display regions L(2i−1) and L2i are formed by one scan electrode Yi and two sustain electrodes Xi and X(i+1) neighboring the scan electrode Yi.

Discharge spaces at crossing regions of the display regions L1 to L(2n−1) and the address electrodes A1 to Am form discharge cells 28 that are partitioned by barrier ribs 29. The sustain electrodes X1 to Xn and the scan electrodes Y1 to Yn extend in a row direction; the sustain electrodes X1 to Xn each include a narrow bus electrode 31a and a wide transparent electrode 31b; and the scan electrodes Y1 to Yn each include a narrow bus electrode 32a and a wide transparent electrode 32b. The transparent electrodes 31b and 32b are respectively coupled to the bus electrodes 31a and 32a. Alternatively, the sustain and scan electrodes may be formed by a wide bus electrode without the transparent electrode, or formed by a transparent electrode without the bus electrode. In addition, although not apparent from the plan view shown in FIG. 2, the barrier rib 29 is formed on the bus electrodes 31a and 32a such that the discharge cell 28 may be partitioned in a column direction.

According to the first exemplary embodiment of the present invention, since each sustain electrode, after the first sustain electrode, shares the two neighboring display regions with two neighboring scan electrodes, the number of sustain and scan electrodes may be reduced compared to a configuration in which each sustain electrode shares only one display region with a neighboring scan electrode on one side. For example, in a PDP including the sustain and scan electrodes sharing one display region, when 512 display regions are driven, the respective numbers of the sustain and scan electrodes are 512 of each type of electrode. However, in a PDP including sustain and scan electrodes sharing two neighboring display regions like the first exemplary embodiment of the present invention, the respective numbers of the sustain and scan electrodes are half of 512. That is, according to the first exemplary embodiment of the present invention, the number of display regions of the PDP may be doubled while keeping the same number of sustain and scan electrodes of a conventional PDP where electrodes share one display region. Alternatively, the number of the sustain and scan electrodes may be reduced in half when the PDP is designed with the same resolution as a PDP including sustain and scan electrodes sharing one display region.

The above PDP configuration is one example, and another configuration applied in another exemplary embodiment of the present invention will now be described. FIG. 3 shows another electrode arrangement diagram of a PDP according to a second exemplary embodiment of the present invention. A driving method applied to the configuration shown in FIG. 3 will now be described. As shown in FIG. 3, the electrode arrangement of the PDP according to the second exemplary embodiment of the present invention is similar to that of the first exemplary embodiment except that each sustain electrode shares only one display region with an adjacent scan electrode on one side. That is, in the PDP according to the second exemplary embodiment of the present invention, an additional barrier rib 29′ is formed along the row direction between the scan electrode Y′i and the sustain electrode X′i+1. Therefore, while one display region is formed between the scan electrode Y′i and the sustain electrode X′i on one side, formation of a second display region on the other side of Y′i is prevented by the barrier rib 29′. In addition, sine the number n of display regions L′i to L′n formed is the same as the number n of the sustain or scan electrodes X′i to X′n or Y′1 to Y′n, transparent electrodes 31b′ and 32b′ of the second embodiment may be formed only toward the one display region. This is in contrast to FIG. 2, where the transparent electrodes 31b and 32b of the first embodiment appear on both sides of the narrow bus electrodes 31a and 32a and extend toward both display regions on the two sides of a sustain or a scan electrode.

Therefore, in the second embodiment shown in FIG. 3, the number of the display regions is reduced by half (i.e., n display regions) compared to the first exemplary embodiment. In other words, if the resolution of the PDP is to be kept equal to the PDP of the first embodiment, then the number of sustain and scan electrodes that are required is doubled compared to the number of electrodes used in the first embodiment. However, when a driving method to be described below is applied to the electrode arrangement according to the second exemplary embodiment of the present invention, a scan pulse is concurrently applied to two scan electrodes for an address period. The driving method to be described below may be applied to either the first or the second embodiment. However, when applied to the PDP of the second embodiment, the scan pulse is concurrently applied to two scan electrodes for the address period since one scan circuit is coupled to two scan electrodes.

The driving method for driving the plasma display device having the PDP according to the first and second exemplary embodiments will now be described. Hereinafter, for convenience of description, the driving method for driving the plasma display device will be described with reference to the PDP according to the first exemplary embodiment of the present invention shown in FIG. 2. The driving method for driving the PDP according to the second exemplary embodiment of the present invention shown in FIG. 3 is similar to that according to the first exemplary embodiment of the present invention except that the scan pulse applied for the address period of each subfield is concurrently applied to two scan electrodes.

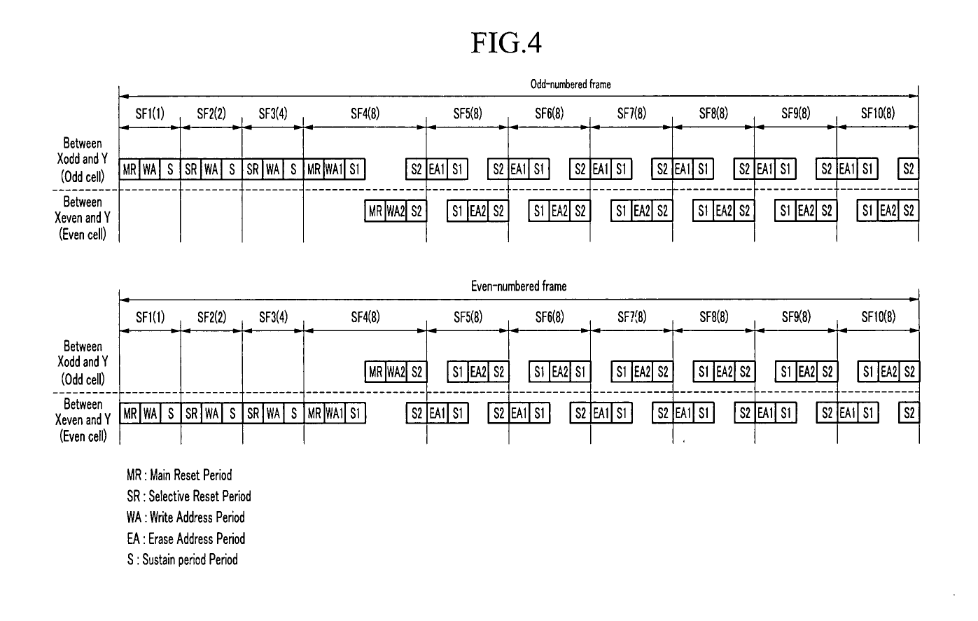

FIG. 4 shows a diagram for representing an exemplary driving method according to embodiments of the present invention.

Hereinafter, a discharge cell on a display region formed between an odd-numbered sustain electrode Xodd and one of the scan electrodes Y1 to Yn will be referred to as “an odd cell”, and a discharge cell on a display region formed between an even-numbered sustain electrode Xeven and one of the scan electrodes Y1 to Yn will be referred to as “an even cell”. In addition, a discharge cell having enough wall charges to generate a sustain discharge for the sustain period will be referred to as “an on-cell,” and a discharge cell not having enough wall charges to generate the sustain discharge for the sustain period will be referred to as “an off-cell.” In addition, a reset period for reset discharging both sustain-discharged cells and cells not having been sustain-discharged in a previous subfield so as to initialize the cells will be referred to as “a main reset period MR.” A reset period for reset discharging only the cells that have been sustain-discharged in a previous subfield so as to initialize these cells will be referred to as “a selective reset period SR.” In addition, an address period for applying a write addressing method will be referred to as “a write address period WA,” and an address period for applying an erase addressing method will be referred to as “an erase address period EA.” The write addressing method is to discharge the cell in a non-emitting state so as to switch the non-emitting or off state to a light-emitting or on state. The erase addressing scheme is to discharge a cell in the on state so as to switch the on state to the off state.

As shown in FIG. 4, in the driving method according to the exemplary embodiment of the present invention, frames are divided into odd-numbered frames and even-numbered frames. Further, each odd or even frame is divided into a plurality of subfields SF1 to SF10. The subfields SF1 to SF10 each have a weight that may be predetermined. The weight of each subfield is included in parenthesis next to the subfield (e.g., SF1(1) or SF5(8)). While FIG. 4 illustrates the subfields SF1 to SF10 as respectively having weights of 1, 2, 4, 8, 8, 8, 8, 8, 8, and 8 according to one exemplary embodiment, the subfields SF1 to SF10 may have different weights in other embodiments.

In the first to third subfields SF1 to SF3 of the odd-numbered frame, subfield operations are performed for the odd cells but no operations are performed for the even cells. Conversely, in the first to third subfields SF1 to SF3 of the even-numbered frame, subfields operations are performed for the even cell to be driven, but no operations are performed for the odd cell. Accordingly, light is emitted in the first to third subfields SF1 to SF3 once every two frames. That is, in order for the first to third subfields SF1 to SF3, which are low grayscale subfields, to be realized by all of the cells including both the odd cells and the even cells, two frames (i.e., odd- and even-numbered frames) are required.

The following few paragraphs describe a method for driving the device during the odd-numbered frame. The first subfield SF1 of the odd-numbered frame includes a main reset period MR, a write address period WA, and a sustain period S. Subsequently, the second and third subfields SF2 and SF3 each have a selective reset period SR, the write address period WA, and the sustain period S. As described above, in the first to third subfields SF1 to SF3, operations of the reset, address, and sustain periods are performed for the odd cell. In addition, while in FIG. 4 the reset periods of the second and third subfields SF2 and SF3 are shown as the selective reset period SR so as to shorten the reset period and increase a contrast ratio, the main reset period MR may be substituted for the selective reset periods SR of the second and third subfields SF2 and SF3.

Subsequently, in the fourth subfield SF4 of the odd-numbered frame, operations of the main reset period MR, a second write address period WA2, and a second sustain period S2 are performed for the even cell after operations of the selective reset period SR, a first write address period WA1, and a first sustain period S1 are performed for the odd cell. Since no operation has been performed for the even cell in the previous subfields SF1 to SF3, the operation of the main reset period MR is performed for the even cell in the fourth subfield SF4 so as to initialize the even cell. In addition, when a sustain discharge is generated for the second sustain period S2 in the even cell, a second sustain discharge is also generated in the odd cell.

Further subfield operations are performed for the odd cells and the even cells in the fifth to tenth subfields SF5 to SF10. The fifth to tenth subfields SF5 to SF10 each include first or second erase address periods EA1 and EA2 and first or second sustain periods S1 and S2 or the first sustain period S1 alone. In the fifth to tenth subfields SF5 to SF10, an operation of the first erase address period EA1 and an operation of the first sustain period S1 are performed for the odd cell, and subsequently, an operation of the second erase address period EA2 and an operation of the second sustain period S2 are performed for the even cell. Since the cells discharged during the sustain period of the fourth subfield SF4 have emitted light, cells to be selected from the light emitted cells are set to the off state during the erase periods EA1 and EA2 of the fifth subfield SF5. Similarly, in the erase address periods EA1 or EA2 of the sixth to tenth subfields SF6 to SF10, cells to be set to the off state are selected from the cells sustain-discharged during the sustain period of the previous subfield (i.e., the on-cells). During the sustain periods S1 and S2 in FIG. 4, the sustain discharge may be generated in the odd cell and the even cell when a sustain pulse is applied to the odd-numbered sustain electrode Xodd and the even-numbered sustain electrode Xeven.

A driving method of the even-numbered frame is similar to that of the odd-numbered frame described above, except that an order of the operations of the odd cell and the even cell is reversed. Therefore, detailed descriptions of the operation of the even-numbered frame is omitted. That is, during the even-numbered frame, the operations of the reset, write address, and sustain periods are performed only for the even cell in the first to third subfields SF1 to SF3, and in the fourth subfield SF4 the operations of the reset, write address, and sustain periods are performed for the odd cell after these operations are performed for the even cell. In the fifth to tenth subfields SF5 to SF10 of the even-numbered frame, the operations of the erase address period and the sustain period are performed for the even cells before these operations are performed for the odd cells.

In FIG. 4, the weights of the fifth to tenth subfields SF5 to SF10 are the same as that of the fourth subfield SF4 because the cells selected during the erase address period and set to the off state may not be changed to the on state again in a subsequent subfield. In one embodiment, the respective weights of the fifth to tenth subfields SF5 to SF10 may be set to a weight different and for example higher than 8. In this case, not all the 256 grayscales may be expressed. Accordingly, a dithering method may be used to express the 256 grayscale when the weights of the fifth to tenth subfields SF5 to SF10 are set to a value different from 8.

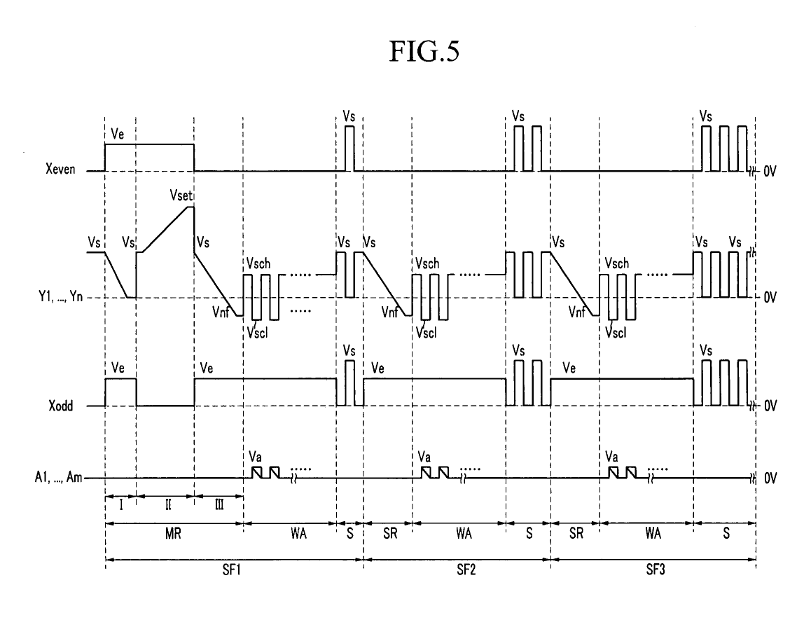

Driving waveforms for using the driving method of FIG. 4 will now be described with reference to FIG. 5 to FIG. 8. The driving waveforms shown in FIG. 5 to FIG. 8 are applied to the odd-numbered frame, and driving waveforms applied to the even-numbered frame are not shown. Driving waveforms for the even-numbered frames may be realized when the driving waveforms applied to the odd-numbered sustain electrode Xodd are applied to the even-numbered sustain electrode Xeven and the driving waveforms applied to the even-numbered sustain electrode Xeven are applied to the odd-numbered sustain electrode Xodd. Therefore, only the driving waveforms applied to the odd-numbered frame will be described.

FIG. 5 shows a diagram representing exemplary driving waveforms applied to the first to third subfields SF1 to SF3 according to the embodiments of the present invention.

As shown in FIG. 5, the first subfield includes the main reset period MR, the write address period WA, and the sustain period S, and the second and third subfields each include the selective reset period SR, the write address period WA, and the sustain period S.

The main reset period MR of the first subfield SF1 includes an erase period I, a rising period II, and a falling period III.

During the erase period I of the main reset period MR, a voltage at the scan electrodes Y1 to Yn is gradually decreased from a voltage Vs to a reference voltage (0V in FIG. 5), while a voltage Ve is being applied to the odd-numbered sustain electrodes Xodd and the even-numbered sustain electrodes Xeven. The voltage Ve may be higher than the reference voltage 0V. During the last subfield of the previous frame and before the erase period I, positive (+) and negative (−) wall charges are formed on respectively the sustain and scan electrodes of the cells having been sustain-discharged in the last subfield of the previous frame. These wall charges are eliminated during the erase period I. Accordingly, a state of the cell having been sustain-discharged in the last subfield prior to the first subfield SF1 becomes similar to that of the cell that has not been sustain-discharged in the previous subfield. FIG. 5 shows a gradually decreasing voltage as the erase waveform applied to the scan electrodes Y1 to Yn during the erase period I of the first subfield. Alternatively, a gradually increasing voltage may be applied to the sustain electrodes Xeven and Xodd while the voltage at the scan electrodes Y1 to Yn is at the reference voltage 0V, or a narrow pulse waveform for eliminating the wall charges may be substituted for the erase waveform. Xodd and Xeven indicate all the odd-numbered and all the even numbered sustain electrodes, respectively.

Subsequently, during the rising period II of the main reset period MR, the voltage at the scan electrodes Y1 to Yn is gradually increased from the Vs voltage to a Vset voltage while the Ve voltage is applied to the even-numbered sustain electrodes Xeven and the reference voltage 0V is applied to the odd-numbered sustain electrodes Xodd. In addition, the reference voltage 0V is applied to the address electrodes A1 to Am. Since the reference voltage 0V is applied to the odd-numbered sustain electrodes Xodd, a weak reset discharge occurs between an odd-numbered sustain electrode Xodd and a scan electrode forming a display region with the odd-numbered sustain electrode Xodd among the scan electrodes Y1 to Yn. Hereinafter, the scan electrode forming the display region with the odd-numbered sustain electrode Xodd will be referred to as “Yxo.”

That is, the Yxo electrode indicates a scan electrode neighboring the odd-numbered sustain electrode Xodd, among all the scan electrodes Y1 to Yn, in an electrode arrangement according to the first exemplary embodiment of the present invention as shown in FIG. 2, and the Yxo electrode indicates the odd-numbered scan electrode Yodd in an electrode arrangement according to the second exemplary embodiment of the present invention as shown in FIG. 3. Further, the scan electrode forming the display region with the even-numbered sustain electrode Xeven will be referred to as “Yxe.” That is, the Yxe electrode indicates a scan electrode neighboring the even-numbered sustain electrode Xeven, in the electrode arrangement according to the first exemplary embodiment of the present invention as shown in FIG. 2. The Yxe electrode also indicates a scan electrode neighboring an even-numbered sustain electrode Xeven in the electrode arrangement according to the second exemplary embodiment of the present invention as shown in FIG. 3.

During the rising period II of the first subfield SF1, since the Ve voltage is applied to the even-numbered sustain electrode Xeven, the reset discharge is not generated between the even-numbered sustain electrode Xeven and a scan electrode Yxe forming the display region with the even-numbered sustain electrode Xeven. In addition, a weak reset discharge is generated between the scan electrodes Y1 to Yn and the address electrodes A1 to Am. Accordingly, negative (−) wall charges are formed in the scan electrode area (transparent electrode) neighboring the odd-numbered sustain electrode Xodd in the electrode arrangement according to the first exemplary embodiment of the present invention as shown in FIG. 2, and negative (−) wall charges are formed at the odd-numbered scan electrodes (Y1′, Y3′, . . . ) in the electrode arrangement according to the second exemplary embodiment of the present invention as shown in FIG. 3. That is, the negative (−) wall charges are formed at the scan electrode Yxo. In addition, positive (+) wall charges are formed on the odd-numbered sustain electrode Xodd, and negative (−) wall charges are formed on the address electrodes A1 to Am. In short, the reset discharge is generated only in the odd cells so as to initialize only the odd cells.

In addition, as a result of the weak discharge that are generated in the cell when the voltage at the electrode is gradually changed as shown in FIG. 5, the wall charges are formed such that a sum of an external voltage and a wall voltage may be maintained at a discharge firing voltage. In addition, the Vset voltage may be high enough to generate a discharge in the cells in every condition since all the odd cells, whether or not they were sustain-discharged in the previous subfield, are required to be initialized during the main reset period of the first subfield. The Vs voltage may be lower than a discharge firing voltage between the scan electrodes Y1 to Yn and the sustain electrodes X1 to Xn. While in FIG. 5 the Vs voltage is set to be equal to the voltage of the sustain discharge pulse applied during the sustain period in order to reduce the number of power sources required, another voltage may be substituted for the Vs voltage. The Ve voltage may be selected such that the reset discharge may not be generated between the scan electrodes and the even-numbered sustain electrodes by a difference between the Vset voltage and the Ve voltage.

During the falling period III of the main reset period MR, the voltage at the scan electrodes Y1 to Yn is gradually decreased from the Vs voltage to a Vnf voltage. In this period, the reference voltage 0V is applied to the even-numbered scan electrodes Xeven, the Ve voltage is applied to the odd-numbered scan electrodes Xodd, and the reference voltage 0V is applied to the address electrodes A1 to Am. While the voltage at the scan electrodes is decreased, a weak reset discharge occurs between the scan electrode Yxo and the odd-numbered sustain electrode Xodd and between the scan electrodes and the address electrodes. Accordingly, negative (−) wall charges formed at the scan electrode Yxo and positive (+) wall charges formed at the odd-numbered sustain electrode Xodd and the address electrodes A1 to Am are eliminated. However, as described above, because a weak discharge is not generated between the scan electrode Yxe and the even-numbered sustain electrode Xeven for the rising period II, and because the reference voltage 0V is applied to the even-numbered sustain electrode Xeven for the falling period III, then the reset discharge is not generated between the scan electrode Yxe and the even-numbered sustain electrode Xeven. Therefore, only the odd cell is reset-discharged to be initialized as the off-cell, and the wall charges are formed such that an address operation may be appropriately performed. In general, the Ve voltage and the Vnf voltage are set such that the wall voltage between the scan electrode Yxo and the odd-numbered sustain electrode Xodd may reach 0V, and therefore a misfiring in the cells that are not discharged in the address period may be prevented in the sustain period. In addition, since the address electrodes A1 to Am are maintained at the reference voltage 0V, the wall voltage between the scan electrode Yxo and the address electrodes A1 to Am is determined by the level of the Vnf voltage.

Since in the main reset period of the first subfield SF1, the reset discharge is generated only in the odd cell, the appropriate wall charges for the address operation are formed at the odd cell. However, appropriate wall charges for the address operation are not formed in the even cell since the reset discharge is not generated therein. In addition, the reset discharge changes the wall charge state of the odd cell and converts the cell into the off state.

Subsequently, in the write address period WA of the first subfield SF1, to select a cell as the on-cell, a scan pulse having a Vscl voltage is applied to the scan electrodes Y1 to Yn. The scan electrodes not receiving the Vscl voltage receive a Vsch voltage. The Vscl voltage is referred to as a scan voltage, and the Vsch voltage is referred to as a non-scan voltage. In the electrode arrangement according to the first exemplary embodiment, the scan pulse having the Vscl voltage is sequentially applied to the scan electrodes and the Vsch voltage is applied to the scan electrodes not receiving the Vscl voltage. For example, the scan pulse is applied to a Y(i+1) electrode after the scan pulse is applied to a Yi electrode. However, in the electrode arrangement according to the second exemplary embodiment, the scan pulse having the Vscl voltage is sequentially applied to pairs of neighboring scan electrodes (Y1 and Y2, Y3 and Y4, Y5 and Y6 . . . ). For example, the scan pulse is concurrently applied to Y(i+2) and Y(i+3) electrodes after the scan pulse is applied to Yi and Y(i+1) electrodes.

In addition, during the write address period WA, the reference voltage 0V and the Ve voltage are respectively applied to the even-numbered sustain electrode Xeven and the odd-numbered sustain electrode Xodd. An address pulse having a Va voltage is applied to address electrodes passing through discharge cells to be selected from a plurality of discharge cells formed along the scan electrodes receiving the Vscl voltage. The other address electrodes are biased at the reference voltage 0V. Then, positive (+) wall charges are formed on the scan electrode, and negative (−) wall charges are formed on the address and sustain electrodes since a discharge is generated at a cell formed by the address electrode receiving the Va voltage, the scan electrode receiving the Vscl voltage, and the even-numbered sustain electrode Xeven receiving the Ve voltage. That is, the cell receiving the Va voltage among the odd cells is changed from the off state to the on state since the address discharge is generated in this cell. However, since the even cell was not initialized in the main reset period MR of the first subfield and the even-numbered sustain electrode Xeven is biased at the reference voltage for the write address period WA, the address discharge is not generated in the even cell. Since discharge cells are selected from the odd cells during the write address period WA of the first subfield SF1, the address pulse is applied to the address electrodes of the odd cells to select the discharge cells.

During the write address period WA of the first subfield SF1, among the discharge cells formed along the Xodd line, the off-cell is changed to the on state due to the wall charges formed by discharging the cell. As a result, the cell is selected to emit light in the sustain period.

For the sustain period S of the first subfield SF1, a sustain pulse having the sustain discharge voltage Vs is alternately applied to the scan electrodes Y1 to Yn and both sets of the sustain electrodes Xodd and Xeven. The sustain discharge is generated by the sustain pulse in the cells that were set to the on state in the write address period WA of the first subfield. The number of the sustain pulses is appropriately selected according to the weight of the first subfield.

Driving waveforms applied in the second subfield SF2 and the third subfield SF3 are similar to the driving waveform of the first subfield SF1 except for the driving waveforms applied for the reset period, and therefore detailed descriptions of them will be omitted.

As shown in FIG. 5, for the reset periods of the second subfield SF2 and the third subfield SF3 which are the selective reset periods SR, the voltage at the scan electrodes Y1 to Yn is gradually decreased from the Vs voltage to the Vnf voltage rather than being gradually increased, and therefore the cells sustain-discharged in the previous subfield are reset-discharged.

For the sustain period of the first subfield SF1 prior to the second subfield SF2, negative (−) wall charges and positive (+) wall charges are respectively formed on the scan electrode and the sustain electrode of the sustain-discharged cell (i.e., the cell sustain-discharged in the first subfield among the odd cells) since the last sustain pulse is applied to the scan electrode. While the reference voltage 0V and the Ve voltage are respectively applied to the even-numbered sustain electrode Xeven and the odd-numbered sustain electrode Xodd, a voltage gradually decreased from the Vs voltage to the Vnf voltage is applied to the scan electrodes Y1 to Yn. Then, the reset discharge is generated in the cell sustain-discharged for the sustain period of the first subfield SF1. Reset discharge is not generated in the cells that were not sustain-discharged during the sustain period of the first subfield. However, it is not required to reset-discharge the cells that were not sustain-discharged in the first subfield among the odd cells since these cells are maintained at the wall charge state formed after the main reset period MR. Accordingly, the voltage that is gradually decreased from the Vs voltage to the Vnf voltage is appropriate to reset-discharge only the cells that were sustain-discharged in the first subfield SF1. In addition, for the selective reset period SR of the second subfield, since the Ve voltage is applied to the odd-numbered sustain electrode Xodd, the reset discharge is generated in the cell that is sustain-discharged in the first subfield SF1 among the odd cells. The voltage Ve prevents the other cells that do not have the appropriate wall charges from being reset. Therefore, after the selective reset period SR of the second subfield SF2, all the odd cells are initialized as off-cells. The odd cells that were sustain-discharged in the first subfield SF1 were reset-discharged and initialized during SR, and the odd cells that were not sustain-discharged in SF1 maintain the wall charge state formed after the main reset period MR of the first subfield SF1.

Operation of the selective reset period SR of the third subfield SF3 is similar to that of the selective reset period SR of the second subfield, and therefore detailed description thereof will be omitted. The number of the sustain pulses for the sustain periods of the second subfield SF2 and the third subfield SF3 is appropriately selected according to the weight of the corresponding subfield.

The reset, write address, and sustain discharge operations are performed by the driving waveforms shown in FIG. 5 in the odd cells during the first to third subfields SF1 to SF3.

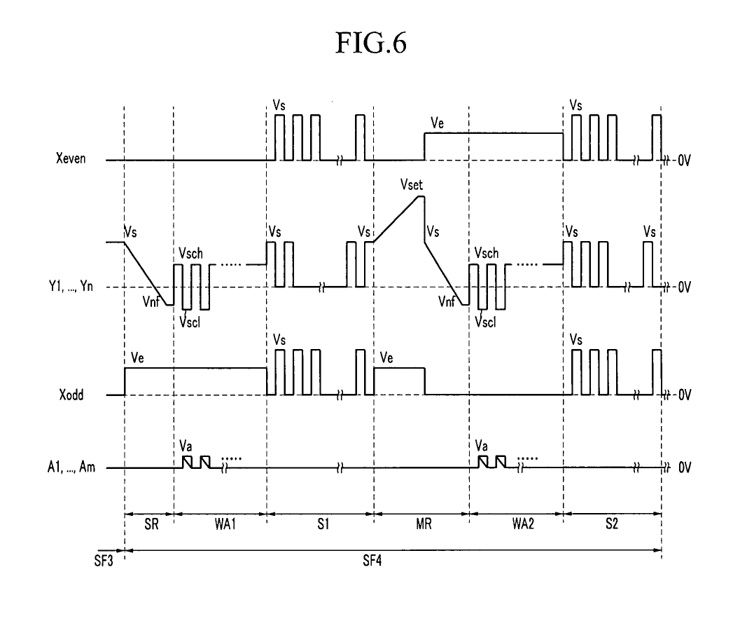

FIG. 6 shows a diagram representing the driving waveforms applied in the fourth subfield SF4 according to an exemplary embodiment of the present invention.

First, the operations of the selective reset period SR, the first write address period WA1, and the first sustain period S1 are performed for the odd cell. As shown in FIG. 6, the driving waveforms of the selective reset period SR, the first write address period WA1, and the first sustain period S1 in the fourth subfield are similar to those in the second subfield SF2 or the third subfield SF3, except that the number of sustain pulses applied for the first sustain period to set the weight is different, and therefore detailed description thereof will be omitted. That is, for the selective reset period SR, the reset operation for initializing the odd cells as an off-cells is performed since the voltage at the scan electrodes Y1 to Yn is gradually decreased from the Vs voltage to the Vnf voltage while the Ve voltage is applied to the odd-numbered sustain electrodes Xodd. Subsequently, the write address operation for selecting the cells to be set as the on-cells among the odd cells is performed in the first write address period WA1. Then, the sustain discharge operation is performed in the first sustain period S1 by alternately applying the sustain pulse to the scan electrodes Y1 to Yn and the sustain electrodes Xeven and Xodd.

Subsequently, the operations of the main reset period MR, the second write address period WA2, and the second sustain period S2 are performed for the even cell.

As shown in FIG. 6, for the main reset period MR, the voltage at the scan electrodes Y1 to Yn is gradually increased from the Vs voltage to the Vset voltage while the reference voltage 0V and the Ve voltage are respectively applied to the even-numbered sustain electrodes Xeven and the odd-numbered sustain electrodes Xodd. A voltage that is gradually decreased from the Vs voltage to the Vnf voltage is applied to the scan electrodes Y1 to Yn while the Ve voltage and the reference voltage 0V are respectively applied to the even-numbered sustain electrodes Xeven and the odd-numbered sustain electrodes Xodd. That is, the driving waveforms applied to the even-numbered sustain electrodes Xeven and the odd-numbered sustain electrodes Xodd for the main reset period MR of the first subfield SF1 shown in FIG. 5 are switched between the two sets of electrodes in FIG. 6. Therefore, since the reset discharge is generated in the even cells, the even cells are initialized to the off state.

Subsequently, for the second write address period WA2 differing from the write address period WA of the first subfield SF1, since the Ve voltage and the reference voltage 0V are respectively applied to the even-numbered sustain electrodes Xeven and the odd-numbered sustain electrodes Xodd, the write address operation is performed in the even cells.

In addition, for the second sustain period S2, the sustain discharge is generated in the cells selected during the second write address period WA2 since the sustain pulse is alternately applied to the scan electrodes Y1 to Yn and the sustain electrodes Xeven and Xodd. At this time, the cells sustain-discharged in the first sustain period S1 maintain their on state because no discharge was generated in these cells during the main reset period MR or the second write address period WA2. Accordingly, when the sustain pulse is applied in the second sustain period S2, sustain-discharge is also generated in the cells that were sustain-discharged during the first sustain period S1. That is, the cells set to the on-state or the on state during both the first and second write address periods WA1 and WA2 are sustain-discharged during the second sustain period S2. Therefore, since the odd cells are sustain-discharged during both the first and second sustain periods, more sustain discharges are generated in the odd cells compared to the even cells.

In the first sustain period S1 in the fourth subfield, the last sustain pulse is applied to the scan electrodes Y1 to Yn. Accordingly, negative (−)and positive (+) wall charges are respectively formed on the scan electrode and the sustain electrode of the cell sustain-discharged in the first sustain period S1. These cells are on-cells due to the sustain discharge. Therefore, a wall voltage Vwxy is formed such that a potential of the sustain electrode is higher than that of the scan electrode.

The wall charge state in the above cell is still maintained at the end of the main reset period MR since the reset discharge is not generated in the cell during the main reset period MR.

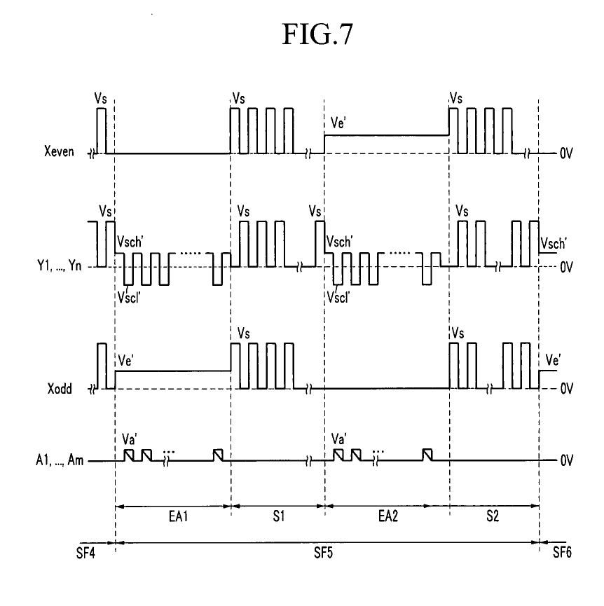

FIG. 7 shows a diagram representing the driving waveforms applied during the fifth subfield SF5 among the driving waveforms of the plasma display device according to the exemplary embodiment of the present invention.

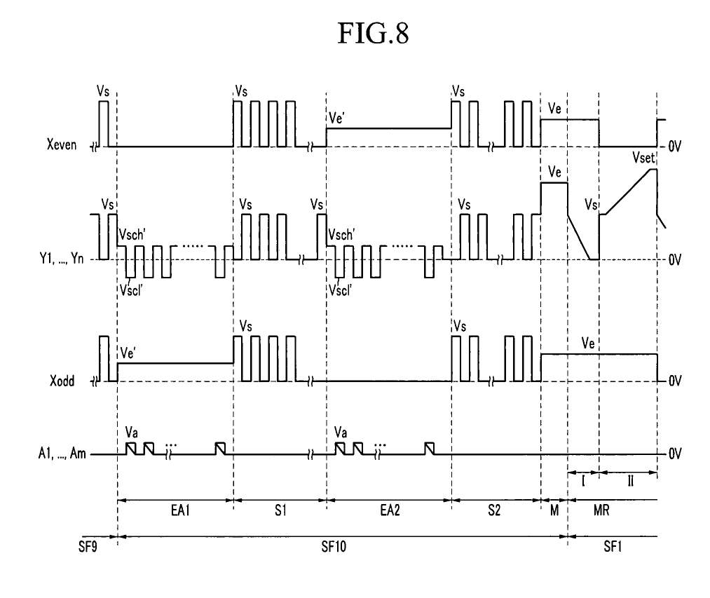

As shown in FIG. 7, the fifth subfield SF5 includes the first erase address period EA1 for the odd cells, the first sustain period S1, the second erase address period EA2 for the even cells, and the second sustain period S2. In order to use the erase addressing method in a cell, the cell is required to be in the on state. Since the cell that is sustain-discharged in the fourth subfield SF4 is in the on state, the first erase address period EA1 may be provided first in the fifth subfield SF5 as shown in FIG. 8.

For the first erase address period EA1 of the fifth subfield SF5, a ground voltage 0V and a Ve′ voltage are respectively applied to the even-numbered sustain electrodes Xeven and the odd-numbered sustain electrodes Xodd. A scan voltage having a Vscl′ voltage is sequentially applied to the scan electrodes Y1 to Yn and a Vsch′ voltage is applied to the scan electrodes Y1 to Yn not receiving the Vscl′ voltage in the electrode arrangement according to the first exemplary embodiment of the present invention. The scan pulse having the Vscl′ voltage is sequentially applied to pairs of neighboring scan electrodes (Y1 and Y2, Y3 and Y4, Y5 and Y6, . . . ) and the Vsch′ voltage is applied to the scan electrodes not receiving the Vscl′ voltage in the electrode arrangement according to the second exemplary embodiment of the present invention. The Ve′ voltage is less than the Ve voltage applied for the write address period of the first to fourth subfields. Since the last sustain pulse is applied to the scan electrodes Y1 to Yn for the second sustain period S2 of the fourth subfield SF4, negative (−) and positive (+) wall charges are respectively formed on the scan and sustain electrodes of the cells sustain-discharged in the sustain period of the fourth subfield. The sustain discharge is generated between the scan electrode receiving the scan voltage Vscl′ and the address electrode receiving the address voltage Va′ since a difference of (Va′+|Vscl′|) between the scan voltage Vscl′ and the address voltage Va′ is added to the wall voltage formed by the wall charges of the sustain discharged cell. Wall charges are eliminated between the scan electrode and the odd-numbered sustain electrode Xodd receiving the Ve′ voltage since the sustain discharge between the scan and address electrodes is spread to between the scan and sustain electrodes, and therefore the cell state is converted from the light emitting state to the off state. However, the even-numbered sustain electrode Xeven is biased at the reference voltage 0V. Therefore, when the scan voltage Vscl′ and the address voltage Va′ are respectively applied to the scan and address electrodes, a weak discharge is generated between the scan and address electrodes that is not spread to the even-numbered sustain electrode Xeven. Accordingly, an erase address operation is not performed at the even cells when the scan voltage Vscl′ and the address voltage Va′ are applied to the even cells. Accordingly, the erase address operation may be performed by the scan voltage Vscl′ and the address voltage Va′ at the odd cells formed by the odd-numbered sustain electrodes Xodd receiving the Ve′ voltage. But it may not be performed by the scan voltage Vscl′ and the address voltage Va′ at the even cells formed by the even-numbered sustain electrodes Xeven not receiving the Ve′ voltage.

That is, the erase address operation may be determined depending on whether the Ve′ voltage is applied. Therefore, in the first erase address period EA1, the erase address operation is performed at the cell selected from the odd cells since the cell state is converted from the light emitting state to the off state.

Because the last sustain pulse is applied to the scan electrodes Y1 to Yn, considerable negative (−) and positive (+) wall charges are formed on the scan and sustain electrodes of the cell that is sustain-discharged in the sustain period of the fourth subfield SF4. Therefore the erase address operation may be performed by the Ve′ voltage that is lower than the Ve voltage. Accordingly, a level of the Ve′ voltage applied for the first erase address period EA1 is less than a level of the Ve voltage, as described above. However, the Ve voltage applied for the write address period of the first to fourth subfields SF1 to SF4 is set to a higher voltage since comparatively smaller amounts of wall charges are formed after the reset period. In addition, the scan voltage Vscl′ and the non-scan voltage Vsch′ for the first erase address period EA1 may be set respectively higher than the scan voltage Vscl and the non-scan voltage Vsch for the write address period of the first to fourth subfields SF1 to SF4. This is due to the fact that the erase operation of the first erase address period EA1 is to set the sustain-discharged cells to the off state. In addition, a width of the scan pulse applied for the first erase address period EA1 may be reduced to less than that applied for the write address period of the first to fourth subfields SF1 to SF4. Since the erase address operation is to change the on state to the off state, the scan pulse width for the erase address period may be reduced to less than that for the write address period not to provide time for forming wall charges by the discharge.

For the first sustain period S1 of the fifth subfield SF5, the cell remaining in the on state is sustain-discharged by alternately applying the sustain pulse to the scan electrodes Y1 to Yn and the sustain electrodes Xodd and Xeven. In this case, the number of the sustain pulses is appropriately selected according to the weight of the fifth subfield SF5.

The sustain pulses applied during the first sustain period S1 supplement the wall charges of the even cells that were lost in the first erase address period EA1. As described above, when the scan voltage Vscl′ and the address voltage Va′ are respectively applied to the scan and address electrodes for the first erase address period EA1, a weak discharge is generated between the scan and address electrodes of the even cells when the reference voltage 0V is applied to the even-numbered sustain electrode Xeven. As a result of this weak discharge the wall charges formed on the address electrode of the cells in the on state are eliminated. Without the wall charges, the erase address operation would not be appropriately performed at the cells in the on state among the even cells for the second erase address period EA2 since. However, the eliminated wall charges are supplemented by the operation of the first sustain period S1. Since the even cells are not selected to be erased in the first erase address period EA1, the sustain discharge is generated at the light-emitting even cells when the sustain pulse is applied in the first sustain period S1 although some wall charges are eliminated in the first erase address period EA1. The eliminated wall charges are supplemented by the sustain discharge.

Subsequently, the Ve′ voltage and the reference voltage 0V are respectively applied to the even-numbered sustain electrodes Xeven and the odd-numbered sustain electrodes Xodd for the second erase address period EA2. In addition, the scan pulse having the Vscl′ voltage is sequentially applied to the scan electrodes Y1 to Yn and the Vsch′ voltage is applied to the scan electrodes not receiving the Vscl′ voltage in the electrode arrangement according to the first exemplary embodiment of the present invention. The scan pulse having the Vscl′ voltage is sequentially applied to pairs of neighboring scan electrodes (Y1 and Y2, Y3 and Y4, Y5 and Y6, . . . ) and the Vsch′ voltage is applied to the scan electrodes not receiving the Vscl′ voltage in the electrode arrangement according to the second exemplary embodiment of the present invention. Since the Ve′ voltage is applied to the even-numbered sustain electrodes Xeven, the cells to be selected as the off-cells are selected from the even cells in the second erase address period EA2 differing from the first erase address period EA1.

In addition, the sustain pulse is alternately applied to the scan electrodes Y1 to Yn and the sustain electrodes Xodd and Xeven in the second sustain period S2. Then, the cells remaining in the light emitting state are sustain-discharged. Here, the number of the sustain pulses applied during the second sustain period S2 is set to be equal to the number of the sustain pulses applied during the first sustain period S1. In addition, some wall charges of the odd cells remaining in the light emitting state are eliminated in the second erase address period EA2, but the eliminated wall charges are supplemented by the sustain discharge in the second sustain period S2 the same way they were supplemented during the first sustain period S1. Accordingly, the erase address operation is appropriately performed in the odd cells for the first erase address period EA1 of the sixth subfield SF6 following the fifth subfield SF5.

The driving waveforms applied to the sixth to ninth subfields SF6 to SF9 are similar to those of the fifth subfield SF5 shown in FIG. 7, and therefore detailed descriptions thereof will be omitted.

A difference between the wall charge state of the cells after the write address operation and the wall charge state of the cells having the wall charges eliminated due to the erase address operation after the fifth subfield SF5 may cause a problem in the main reset operation. The main reset is designed for the write address operation, and therefore it may not be properly performed in the cells having wall charges eliminated by the erase address operation.

Therefore, a driving waveform of FIG. 8 is applied in the tenth subfield SF10 of the odd-numbered frame in order to stably perform the main reset operation during the next frame (even-numbered frame).

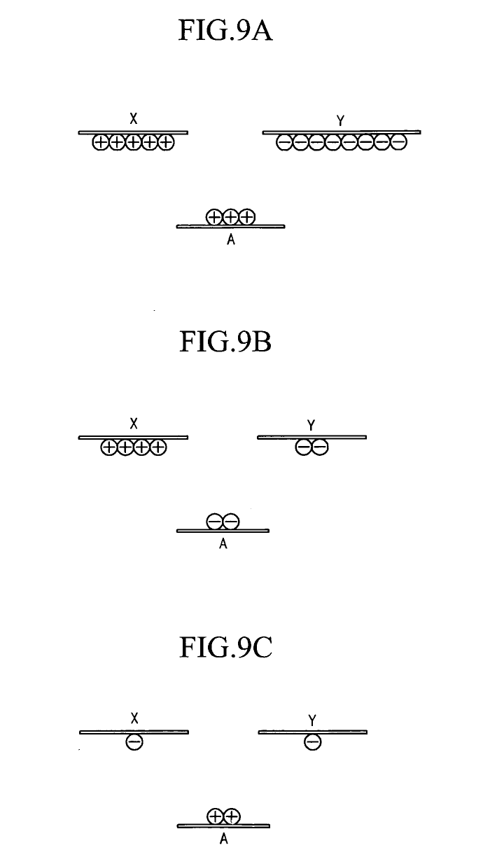

FIG. 8 shows driving waveforms applied to the tenth subfield SF10 among the driving waveforms of the plasma display device according to the exemplary embodiment of the present invention, and FIG. 9A to FIG. 9C show the wall charge distribution state resulting from the driving waveforms of FIG. 8 applied to the plasma display device. For better understanding and ease of description, Y represents an scan electrode selected from the plurality of scan electrodes Y1 to Yn, A represents an address electrode selected from the plurality of address electrodes A1 to Am, and X represents a sustain electrode selected from the plurality of sustain electrodes Xodd and Xeven.

As shown in FIG. 8, the tenth subfield SF10 includes the first erase address period EA1 for the even cells, the first sustain period S1, the second erase address period EA2 for the odd cells, the second sustain period S2, and a correction period M for controlling the wall charge state. The erase address periods EA1 and EA2 and the first and second sustain periods S1 and S2 are similar to those shown in FIG. 7, and therefore detailed descriptions thereof will be omitted.

In general, the sustain discharge pulse is applied to the scan electrodes Y in the fifth to tenth subfields SF5 to SF10 and thus the wall charge state of the sustain-discharged cell becomes the wall charge state shown in FIG. 9A. That is, a relatively large amount of negative (−) wall charges is formed on the scan electrodes Y, and positive (+) wall charges are formed on the sustain electrodes Xodd and Xeven and the address electrodes A.

When the erase address operation is performed at the cells selected to be non-emitting during the erase address period in the fifth to the tenth subfields SF5 to SF10, erase-discharging is generated between the scan electrodes Y and the address electrodes A during the erase address period such that the wall charges are erased. That is, when the erase-addressing is generated, a negative (−) Vscl′ voltage is applied to the scan electrodes Y and a positive (+) Va′ voltage is applied to the address electrodes A such that most of the negative (−) wall charges formed on the scan electrodes Y are erased and negative (−) wall charges are formed on the address electrodes A as shown in FIG. 9B.

However, when negative (−) wall charges are formed on the address electrodes A as shown in FIG. 9B, a subsequent reset operation may not be properly performed. When the main reset period MR of the first subfield SF1 of the even-numbered frame is performed, if the wall charges are as shown in FIG. 9B, then a strong discharge is generated between the address electrodes A and the scan electrodes Y during the rising period II of the main reset period MR and thus the reset operation is not appropriately performed.

Therefore, as shown in FIG. 8, a correction period M is added after the second sustain period S2 is performed in the tenth subfield SF10. A voltage Vc that is higher than the Vs voltage is applied to the scan electrodes Y during the correction period M. That is, a voltage difference between the address electrodes A and the scan electrodes Y becomes the voltage Vc which is greater than the voltage Vs when the voltage Vc is applied to the scan electrodes Y while the ground voltage is applied to the address electrodes A. During this correction period M, the voltage Ve is applied to the sustain electrodes Xodd and Xeven. Therefore, positive (+) wall charges are formed on the address electrodes A and negative (−) wall charges are formed on the scan electrodes Y.

Prior to the correction period M, when the sustain-discharging is generated in the cells in the tenth subfield SF10, the cells maintain the same wall charge state shown in FIG. 9A even after the voltage Vc is applied. That is, the last sustain pulse is applied to the scan electrodes Y and thus negative (−) wall charges are formed thereon, and accordingly the wall charge state is not changed even though the voltage Vc is applied to the scan electrodes Y.

Therefore, when the correction period M is performed, the discharging is generated at the erase-addressed cell, and therefore the wall charge state of the cell is changed similar to the wall charge state of the sustain-discharged cell as shown in FIG. 9A.

Therefore, the erase-addressed cell in the wall charge state of FIG. 9A is initialized by a weak reset discharge generated between the even cell and its neighboring scan electrode during the main reset period MR, and changed to the wall charge state of FIG. 9C.

At this time, the voltage Vc can be set to be a sum of the Vs voltage, the Vsch voltage, and the Vscl voltage in order to reduce the number of power sources.

The correction period M is included in the tenth subfield SF10 as shown in FIG. 8. However, the correction period M can be included in the reset period of the even-numbered frame instead.

As described, the number of electrodes can be reduced by sharing of the scan electrode by two neighboring display regions to thereby reduce the number of scan circuits according to the embodiment of the present invention.

In addition, when the write address period and the erase address period are combined in a plurality of subfields, wall charge initialization can be appropriately performed in the next main reset period by adding the correction period.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display device during frames, each frame divided into a plurality of subfields, the plasma display device having a plurality of first electrodes, a plurality of second electrodes, a plurality of third electrodes arranged in a direction crossing a direction of the plurality of first electrodes and the plurality of second electrodes, and cells arranged along the plurality of first electrodes and the plurality of second electrodes, each cell capable of having an on state and an off state, the cell in the on state being an on-cell and the cell in the off state being an off-cell, the method comprising:
during an address period of a first subfield, selecting on-cells by converting one or more of the cells from the on state into the off state according to a first addressing scheme;
during a sustain period of the first subfield, alternately applying a first voltage to the plurality of first electrodes and the plurality of second electrodes, the first voltage being a sustain discharge voltage;
during a first period directly preceding a second subfield, establishing a second voltage as a voltage difference between the plurality of first electrodes and the plurality of third electrodes, the second voltage being greater than a voltage difference between the plurality of first electrodes and the plurality of third electrodes in the sustain period of the first subfield; and
during the second subfield, converting one or more of the cells from the off state into the on state according to a second addressing scheme and sustain-discharging the converted cells.

2. The method of claim 1, wherein, during the first period, a voltage equal to the second voltage is applied to the plurality of first electrodes and a ground voltage is applied to the plurality of third electrodes.

3. The method of claim 1, wherein, during the second subfield, a voltage of the plurality of first electrodes is gradually increased and then decreased.

4. The method of claim 3, wherein the first period is provided directly before a reset period of the second subfield.

5. The method of claim 1, wherein the first subfield is included in a first frame and the second subfield is included in a second frame consecutive to the first frame.

6. The method of claim 5, wherein the first addressing scheme is used in the first frame and the second addressing scheme is used in the second frame.

7. The method of claim 5, wherein the first subfield is provided at an end of the first frame.

8. The method of claim 1, wherein the cells converted to the off state according to the first addressing scheme during the address period of the first subfield are discharged during the first period.

9. The method of claim 1, wherein a last sustain pulse having the first voltage is applied to the plurality of first electrodes during the sustain period of the first subfield.

10. The method of claim 1, wherein a plurality of display regions are provided between the plurality of first electrodes and the plurality of second electrodes.

11. The method of claim 1:
wherein a display region is formed between each pair of first and second electrodes adjacent to each other, and
wherein a scan pulse is concurrently applied to a pair of first electrodes among the plurality of first electrodes in the first addressing scheme and the second addressing scheme.

12. The method of claim 1, wherein, during the address period of the first subfield, while a third voltage being lower than the first voltage is applied to the plurality of second electrodes, the plurality of first electrodes apply a fourth voltage to the off-cells and apply a scan pulse having a fifth voltage being lower than the fourth voltage to the on-cells.

13. The method of claim 12, wherein the second voltage is higher than the first voltage, and a voltage difference between the first voltage and the second voltage corresponds to a voltage difference between the fourth voltage and the fifth voltage.

14. A method for driving a plasma display device having a plurality of first electrodes, a plurality of second electrodes, a plurality of third electrodes arranged in a direction crossing a direction of the plurality of first electrodes and the plurality of second electrodes, and cells arranged along the plurality of first electrodes and the plurality of second electrodes, each cell capable of having an on state and an off state, the cell in the on state being an on-cell and the cell in the off state being an off-cell, the method comprising:
selecting a plurality of on-cells according to a first addressing scheme, the first addressing scheme converting one or more of the cells from the on state into the non-emitting state;
sustain-discharging the selected cells;
in a first period, discharging the cells converted into the off state according to the first addressing scheme; and
generating a reset discharge for initializing all the off-cells and the on-cells.

15. The method of claim 14, wherein a second addressing scheme for converting an off-cell into an on-cell is applied in a subfield including the reset discharge.

16. The method of claim 14, wherein the generating of a reset discharge includes gradually increasing and subsequently decreasing a voltage of the plurality of first electrodes.

17. A plasma display device comprising:
a plasma display panel having a plurality of first electrodes, a plurality of second electrodes, and a plurality of third electrodes arranged in a direction crossing a direction of the plurality of first electrodes and the plurality of second electrodes; and
a driver for applying a voltage for causing a voltage difference between the plurality of first electrodes and the plurality of third electrodes during a first period between a first subfield and a second subfield, to be greater than a voltage difference in a sustain period of the first subfield, the driver alternately applying a first voltage to the plurality of first electrodes and the plurality of second voltages during the sustain period of the first subfield according to a first addressing scheme, the first addressing scheme converting an on-cell into an off-cell, and converting an off-cell to an on-cell during the second subfield according to a second addressing scheme.

18. The plasma display device of claim 17, wherein during the first period, the driver applies a second voltage being higher than the first voltage to the plurality of first electrodes and applies a ground voltage to the plurality of third electrodes.

19. The plasma display device of claim 17, wherein the on-cell converted into the off-cell according to the first addressing scheme during the first subfield generates a discharge during the first period.

20. The plasma display device of claim 17,
wherein the first period is provided directly before a reset period of the second subfield, and
wherein the driver gradually increases and subsequently decreases a voltage of the plurality of first electrodes.

21. The plasma display device of claim 17, wherein the first subfield is included in a first frame and the second subfield is included in a second frame consecutive to the first frame, the first frame using the first addressing scheme and the second frame using the second addressing scheme.
